(19) United States
(12) Patent Application Publication
(10) Pub. No.: US 2007/0024216 A1
(43) Pub. Date: Feb. 1, 2007

(54) VIDEO DISPLAY APPARATUS AND VIDEO DISPLAY METHOD

(76) Inventor: Sang-soo JO, Hwaseong-si (KR)

Correspondence Address: STANZIONE & KIM, LLP, 919 18TH STREET, N.W., SUITE 440, WASHINGTON, DC, 20006, US

(21) Appl. No.: 11/460,030

(22) Filed: Jul. 26, 2006

(30) Foreign Application Priority Data
Jul. 27, 2005 (KR) 2005-68580

(51) Int. Cl. H01J 29/70

(52) U.S. Cl. 315/364

(57) ABSTRACT

A video display apparatus including a display unit and a horizontal deflector to deflect a beam scanned onto the display unit based on a video signal including horizontal synchronization information. The video display apparatus may further include a signal generator to generate a pulse signal having a predetermined duty ratio based on the horizontal synchronization information of the video signal, a driver to transform a predetermined power source voltage into a driving current to drive the horizontal deflector in correspondence to the pulse signal and to output the driving current to the horizontal deflector, a memory to store duty ratio information of the pulse signal corresponding to the driving current for the horizontal deflector, and a controller to control the signal generator to generate the pulse signal having the duty ratio corresponding to the duty ratio information stored in the memory.

### CROSS-REFERENCE TO RELATED APPLICATIONS

This application claims priority under 35 U.S.C. §119(a) from Korean Patent Application No. 2005-0068580, filed on Jul. 27, 2005, in the Korean Intellectual Property Office, the disclosure of which is incorporated herein by reference.

### BACKGROUND OF THE INVENTION

1. Field of the Invention

The present general inventive concept relates to a video display apparatus and a video display method, and more particularly, to a video display apparatus and a video display method that can stably perform a horizontal deflection with regard to a high horizontal frequency.

2. Description of the Related Art

A video display apparatus, such as a television, a monitor, or the like, receives a video signal corresponding to a predetermined image from an airwave television broadcast, a cable television broadcast, etc., or receives a video signal from a personal computer (PC). Further, the video display apparatus processes the received video signal, thereby displaying a predetermined image.

Such a video display apparatus sequentially scans a plurality of horizontal lines in a vertical direction, and displays a unit image, i.e., a frame, successively with a lapse of time. In this case, the video display apparatus deflects scanning light so as to display an image based on the received video signal at a proper position of a display panel. For example, in the video display apparatus, an electron gun generates an electron beam toward the display panel based on the received video signal. An optical path of the straight electron beam is changed left, right, up, and down by a horizontal deflection coil and a vertical deflection coil, thereby scanning the electron beam on a fluorescent surface of the display panel. In this case, the horizontal deflection coil and the vertical deflection coil employ an electromagnetic force for curving the optical path of the straight electron beam. Here, the curvature of the electron beam is varied depending on the direction or the intensity of a current flowing in the coils.

FIG. 1 is a block diagram illustrating a schematic configuration of a conventional video display apparatus 1 performing a horizontal deflection. The conventional video display apparatus 1 includes a signal generator 11, a base drive circuit 12, a horizontal drive transformer (HDT) 13, a horizontal deflection circuit 14, and a display unit 15. The signal generator 11 receives horizontal synchronization information about a video signal, and periodically generates a pulse signal according to a timing based on the horizontal synchronization information. Here, the pulse signal generated by the signal generator 11 includes a square wave signal, which is also called a base drive signal.

The base drive circuit 12 is placed in an output terminal of the signal generator 11, and receives the pulse signal, thereby controlling the output of the HDT 13. Here, the HDT 13 includes a transformer provided with a primary coil and a secondary coil, which transforms a current flowing in the primary coil by a predetermined ratio, and outputs it through the secondary coil. In this case, the base drive circuit 12 includes a switching device to be turned on or off by a logical state of the input pulse signal. As the switching device is turned on or off, the current is allowed to flow in or is prevented from flowing in the primary coil of the HDT 13.

The horizontal deflection circuit 14 includes a bipolar junction transistor, and receives the current output from the HDT 13 through a base of the bipolar junction transistor. The horizontal deflection circuit 14 amplifies the input base current by a predetermined current amplification ratio through the bipolar junction transistor, and applies a horizontal deflection, based on the amplified current, to the electron beam corresponding to the video signal on the display unit 15 by using a horizontal deflection coil.

In the conventional video display apparatus 1, a power source voltage B+causing the current to flow in the primary coil of the HDT 13 is applied through a resistor R having a predetermined resistance value. As described above, the bipolar junction transistor of the horizontal deflection circuit 14 has the current amplification ratio of a collector current to a base current. Here, the current amplification ratio importantly contributes to determining a degree of the horizontal deflection. Therefore, in the conventional video display apparatus 1, the HDT 13 and the base drive circuit 12 have been designed in consideration of the current amplification ratio of the bipolar junction transistor.

However, the bipolar junction transistor can have various current amplification ratios according to its fabricating conditions, and it is difficult to design the HDT 13 and the base drive circuit 12 to correspond to such various current amplification ratios of the bipolar junction transistor. Alternatively, the level of the power source voltage B+ has been controlled to be adjusted to correspond to various current amplification ratios of the bipolar junction transistor, but it is economically inefficient to vary the level of the power source voltage B+. Therefore, the resistor R having the predetermined resistance is provided between the power source voltage B+ and the HDT 13, so that the power source voltage B+ is dropped to correspond to the current amplification ratio of the bipolar junction transistor.

In a horizontal maximum operation frequency of about 100 KHz, there is no problem in the resistor R having the predetermined resistance. However, in the case where the horizontal deflection is applied to a high horizontal maximum operation frequency of about 120 KHz or more, excessive heat is generated in the resistor R connected to the HDT 13, thereby causing problems in the operation and the stability of the video display apparatus 1. Various tests have been conducted to solve these problems, including lowering the level of the power source voltage B+, and connecting a plurality of resistors R in parallel, but they are not fundamental solutions to the problems.

### SUMMARY OF THE INVENTION

Accordingly, it is an aspect of the present general inventive concept to provide a video display apparatus and a video display method, which can stably perform a horizontal deflection with regard to a high horizontal frequency.

Additional aspects and/or advantages of the present general inventive concept will be set forth in part in the description which follows and, in part, will be obvious from the description, or may be learned by practice of the present general inventive concept.

The foregoing and/or other aspects and utilities of the present general inventive concept can be achieved by providing a video display apparatus comprising a display unit, a horizontal deflector to deflect a beam scanned onto the display unit based on a video signal including horizontal synchronization information, a signal generator to generate a pulse signal having a predetermined duty ratio based on the horizontal synchronization information of the video signal; a driver to transform a predetermined power source voltage into a driving current to drive the horizontal deflector based on the pulse signal and to output the driving current to the horizontal deflector, a memory to store duty ratio information of the pulse signal corresponding to the driving current for the horizontal deflector, and a controller to control the signal generator to generate the pulse signal having the duty ratio corresponding to the duty ratio information stored in the memory.

The driver comprises a driving transformer to transform a current based on the power source voltage into the driving current; and a switching circuit to control the current based on the power source voltage to selectively flow to the driving transformer according to the pulse signal.

The horizontal deflector comprises a bipolar junction transistor to receive the driving current as a base current, and the driving current may correspond to a current amplification ratio of the bipolar junction transistor.

The foregoing and/or other aspects and utilities of the present general inventive concept can also be achieved by providing a video display method useable with a video display apparatus comprising a display unit, a horizontal deflector to deflect a beam scanned onto the display unit based on a video signal including horizontal synchronization information, the video display method comprising storing duty ratio information of a pulse signal corresponding to a driving current to drive the horizontal deflector, generating the pulse signal having a predetermined duty ratio based on the horizontal synchronization information of the video signal, and transforming a predetermined power source voltage into the driving current to drive the horizontal deflector based on the pulse signal to output the driving current to the horizontal deflector.

The horizontal deflector comprises a bipolar junction transistor to receive the driving current as a base current, and the driving current may correspond to a current amplification ratio of the bipolar junction transistor.

The signal generator may be a field effect transistor having a source connected to a transformer, a drain connected to the power supply unit, and a gate connected to the driver. The source and the drain of the field effect transistor may be electrically connected with each other so that the current flows to the horizontal drive transformer to charge the primary coil of the horizontal drive transformer with energy when the pulse signal generated by the signal generator has a low logical state, and the source and the drain of the field effect transistor may be electrically disconnected from each other so that the current is induced from the primary coil into the secondary coil of the horizontal drive transformer by electromagnetic induction and transmitted to the bipolar junction transistor of the horizontal deflection unit when the pulse signal generated by the signal generator has a high logical state. The driver may include a capacitor to filter a direct current component from the signal transmitted from the signal generator to the gate of the field effect transistor, and a plurality of resistors and a diode to adjust a driving level of the field effect transistor and to connect the gate of the field effect transistor to the driver. The driver may include a resistor to protect the field effect transistor from an over current, the resistor being fusible and having a resistance of less than or equal to 1Ω, and a plurality of capacitors to smooth the voltage from the power supply unit.

The foregoing and/or other aspects and utilities of the present general inventive concept may also be achieved by providing a video display apparatus, including a signal generating unit to generate a pulse signal having a predetermined duty ratio based on horizontal synchronization information about a video signal, a transforming unit to transform a current flowing thereto from a power source, a horizontal deflection circuit to use the transformed current to apply a horizontal deflection to an electron beam corresponding to a video signal, and a drive circuit to control the current flow to the transforming unit based on the duty ratio of the pulse signal.

The duty ratio may be based on a predetermined optimum current to be supplied to the horizontal deflection circuit to horizontally deflect the electron beam. The transforming unit may include a primary coil and a secondary coil such that when the pulse signal generated by the signal generating unit is changed according to the duty ratio, the intensity of the current introduced into the horizontal deflection circuit via the primary and secondary coils is varied. The drive circuit may include the transformer unit. The video display apparatus may further include a controller to determine a current amplification ratio and to control the signal generating unit to generate the pulse signal having the duty ratio corresponding to the current amplification ratio. The video display apparatus may further include a memory to store duty ratio information about the pulse signal. The duty ratio information may be information to increase the duty ratio of the pulse signal generated by the signal generating unit for a low current amplification ratio, or the duty ratio information may be information to decrease the duty ratio of the pulse signal generated by the signal generating unit for a high current amplification ratio.

The foregoing and/or other aspects and utilities of the present general inventive concept may also be achieved by providing a video display apparatus, including a controller to control a periodic generation of a pulse signal having a predetermined duty ratio, a transformer unit to transform a first current flowing therefrom to a power source to a second current, a horizontal deflection circuit to receive the transformed second current from the transformer and to apply a horizontal deflection to an electron beam corresponding to a video signal based on the second current, and a drive circuit to receive the generated pulse signal and to control the current flowing from the transformer to the power source based on the duty ratio of the pulse signal.

The foregoing and/or other aspects and utilities of the present general inventive concept may also be achieved by providing a method of displaying an image on a video display apparatus including a signal generating unit, a transforming unit including a primary coil and a secondary coil, a horizontal deflection circuit including a bipolar junction transistor and a horizontal deflection coil, and a drive circuit, the method including periodically generating a pulse signal having a duty ratio using the signal generating unit, transforming a first current flowing from the transforming unit into a second current using the transforming unit, amplifying the second current by a current amplification ratio and applying a horizontal deflection to an electron beam corresponding to a video signal based on the amplified current using the horizontal deflection circuit, and controlling the second current flowing from the transforming unit based on the duty ratio of the pulse signal using the drive circuit.

The method may further include permitting the first current to flow to the primary coil when the pulse signal generated by the signal generator has a low logical state, and inducing the first current from the primary coil into the secondary coil of the horizontal drive transformer by electromagnetic induction and transmitting the second current to the bipolar junction transistor of the horizontal deflection unit when the pulse signal generated by the signal generator has a high logical state. The method may further include changing the duty ratio to a second duty ratio, and controlling the second current flowing from the transforming unit based on the second duty ratio of the pulse signal using the drive circuit.

### BRIEF DESCRIPTION OF THE DRAWINGS

These and/or other aspects and advantages of the present general inventive concept will become apparent and more readily appreciated from the following description of the embodiments, taken in conjunction with the accompany drawings of which:

FIG. 1 is a block diagram illustrating a schematic configuration of a conventional video display apparatus performing a horizontal deflection;

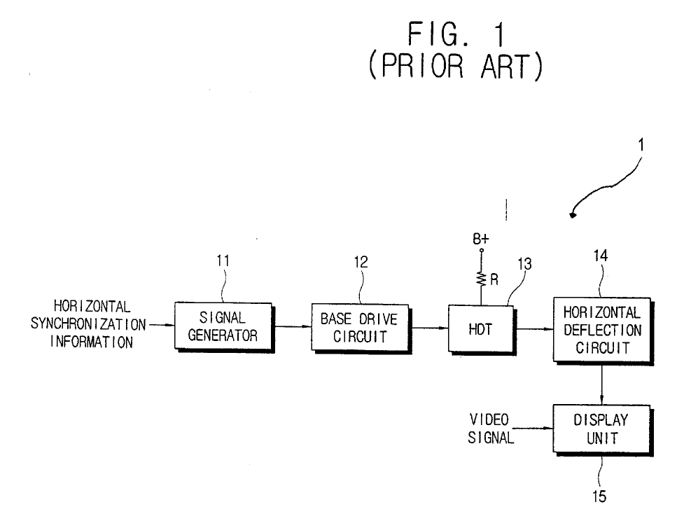

FIG. 2 is a block diagram illustrating a schematic configuration of a video display apparatus according to an embodiment of the present general inventive concept;

FIG. 3 is a circuit diagram illustrating a detailed configuration of a base drive circuit of the video display apparatus in FIG. 2 according to an embodiment of the present general inventive concept; and

FIG. 4 is a flowchart illustrating an operation of the video display apparatus in FIG. 2 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

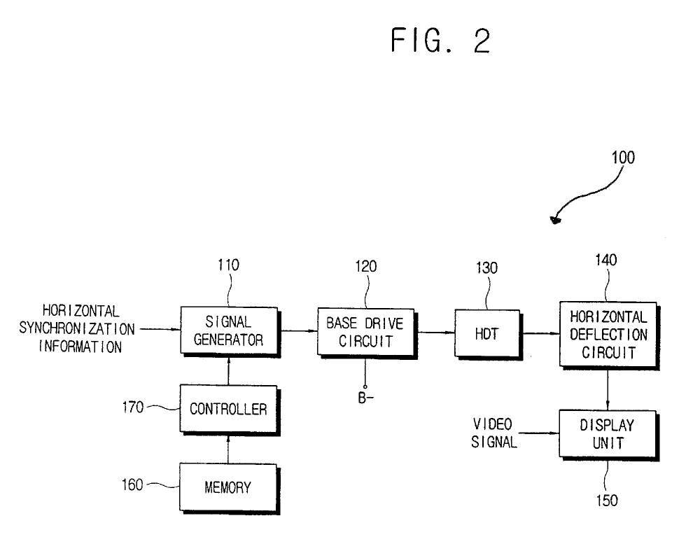

FIG. 2 is a block diagram illustrating a schematic configuration of a video display apparatus 100 according to an embodiment of the present general inventive concept. The video display apparatus 100 may be, for example, a television, a monitor, or the like. The video display apparatus 100 receives a video signal corresponding to a predetermined image from, for example, an airwave television broadcast, a cable television broadcast, or the like, or from a personal computer (PC). Further, the video display apparatus 100 processes the received video signal to display the predetermined image. Particularly, the video display apparatus 100 employs a pulse signal having a duty ratio that is previously set and stored based on an optimum current to be supplied to a horizontal deflection coil. The pulse signal having the duty ratio controls a current supply, so that a heat source, such as a resistor, is not required, thereby stably performing a horizontal deflection at a high horizontal frequency.

As illustrated in FIG. 2, the video display apparatus 100 includes a signal generator 110, a base drive circuit 120, a horizontal drive transformer (HDT) 130, a horizontal deflection circuit 140, a display unit 150, a memory 160, and a controller 170. The signal generator 110 receives horizontal synchronization information about the video signal, and periodically generates a pulse signal according to a timing based on the horizontal synchronization information. Here, the pulse signal generated by the signal generator 110 may include a square wave signal, which has the predetermined duty ratio.

The base drive circuit 120 is located at an output terminal of the signal generator 110, and receives the pulse signal to control the output of the HDT 130. Here, the HDT 130 includes a transformer provided with a primary coil and a secondary coil (not illustrated). The HDT 130 transforms a current flowing in the primary coil by a predetermined ratio, and outputs the transformed current through the secondary coil. The base drive circuit 120 controls the current flowing from a power source voltage B− to the primary coil of the HDT 130 according to a logical state of the input pulse signal.

The horizontal deflection circuit 140 includes a bipolar junction transistor (not illustrated), and receives the current induced in the secondary coil of the HDT 130 through a base of the bipolar junction transistor. The display unit 150 receives the video signal and generates an electron beam corresponding to the video signal to a display panel. The horizontal deflection circuit 140 amplifies the current by a predetermined current amplification ratio through the bipolar junction transistor, and applies a horizontal deflection based on the amplified current to the electron beam through the horizontal deflection coil.

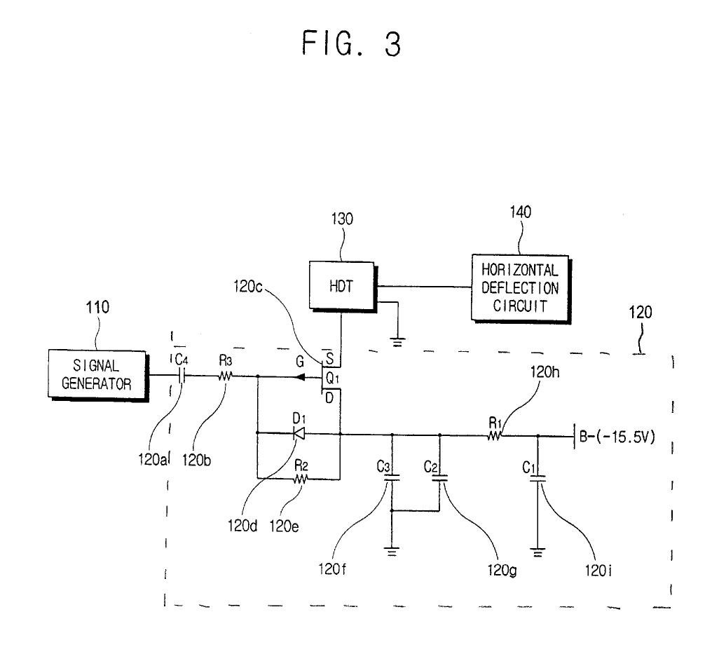

FIG. 3 is a circuit diagram illustrating a detailed configuration of a base drive circuit of the video display apparatus in FIG. 2 according to an embodiment of the present general inventive concept. As illustrated in FIG. 3, the base drive circuit 120 may include a first capacitor (C₁) 120i, a first resistor (R₁) 120h, a second capacitor (C₂) 120f, a third capacitor (C₃) 120g, a second resistor (R₂) 120e, a diode (D₁) 120d, a field effect transistor (FET) (Q₁) 120c, a third resistor (R₃) 120b, and a fourth capacitor (C₄) 120a. The FET 120c may have a source S connected to the primary coil (not illustrated) of the HDT 130, and a drain D connected to a power source voltage B− via the first resistor 120h. Here, the first resistor 120h may be used to protect the FET 120c from an overcurrent. The first resistor 120h may be fusible and may have a low resistance of 1Ω and below. The first through third capacitors 120i, 120g and 120f may be used to smooth the power source voltage B−.

Further, the FET 120c may have a gate G connected to the output of the signal generator 110 through the third resistor 120b and the fourth resistor 120a. The fourth capacitor 120a may filter a direct current component from the signal transmitted from the signal generator 110 to the gate G of the FET 120c. The second resistor 120e and the diode 120d may be used to adjust a driving level of the FET 120c.

When the pulse signal generated by the signal generator 110 is transmitted to the gate G of the FET 120c and has a low logical state, the source S and the drain D of the FET 120c are electrically connected with each other, so that the current flows from the HDT 130 to the power source voltage B-. In this case, the primary coil of the HDT 130 is charged with energy. On the other hand, when the pulse signal generated by the signal generator 110 is transmitted to the gate G of the FET 120c and has a high logical state, the source S and the drain D of the FET 120c are electrically disconnected from each other, so that a predetermined current is induced into the secondary coil of the HDT 130 (not illustrated) by electromagnetic induction. The current induced into the secondary coil of the HDT 130 is introduced to the base of the bipolar junction transistor of the horizontal deflection circuit 140.

When the pulse signal generated by the signal generator 110 is changed according to the duty ratio, the intensity of the current introduced into the horizontal deflection circuit 140 via the primary and secondary coils of the HDT 130 is varied. For example, as the low logical state of the pulse signal becomes longer, the intensity of the current introduced into the horizontal deflection circuit 140 increases. In this embodiment, the base driving circuit 120 and the HDT 130 together are described as an example of a driver according to an embodiment of the present general inventive concept.

Referring to FIG. 2, the memory 160 can store duty ratio information about the pulse signal corresponding to a driving current of the horizontal deflection circuit 140, i.e., corresponding to a suitable current to be introduced into the base of the bipolar junction transistor. In other words, the memory 160 can store the duty ratio information about the pulse signal corresponding to the current amplification ratio of a collector current to a base current in the bipolar junction transistor of the horizontal deflection circuit 140. For example, the duty ratio information may increase the duty ratio of the pulse signal generated by the signal generator 110 for a low current amplification ratio of the bipolar junction transistor, and may decrease the duty ratio of the pulse signal generated by the signal generator 110 for a high current amplification ratio of the bipolar junction transistor.

The controller 170 can receive information about the current amplification ratio of the bipolar junction transistor, and can control the signal generator 110 to generate the pulse signal according to the duty ratio corresponding to the current amplification ratio. The controller 170 may be, for example, a microprocessor (such as a central processing unit (CPU)), and a software program executable by the microprocessor can be stored in the memory 160.

According to an embodiment of the present general inventive concept, the duty ratio information stored in the memory 160 can be used to generate the pulse signal having the duty ratio corresponding to the current amplification ratio of the bipolar junction transistor, so that a resistor does not need to be included to drop a power source voltage to the HDT 130. Therefore, there is no heat generation due to using a resistor.

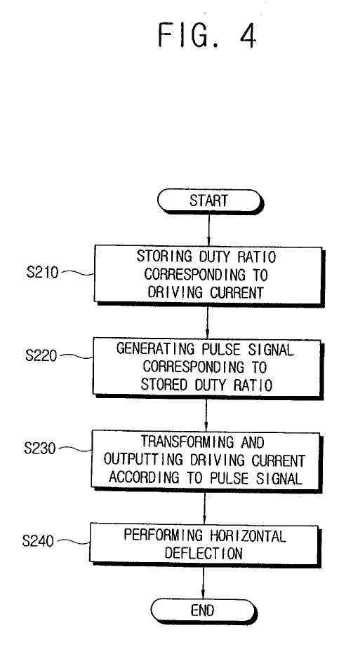

FIG. 4 is a flowchart illustrating an operation of the video display apparatus in FIG. 2. according to an embodiment of the present general inventive concept. At operation S210, the memory 160 stores the duty ratio information about the pulse signal corresponding to a driving current of the horizontal deflection circuit 140, i.e., corresponding to a suitable current to be introduced into the base of the bipolar junction transistor of the horizontal deflection circuit 140. At operation S220, the pulse signal having the duty ratio based on the duty ratio information stored in the memory 160 is generated on the basis of the horizontal synchronization information.

At operation S230, a predetermined current from the power source voltage B− is transformed into the driving current corresponding to the duty ratio of the pulse signal, and the driving current is supplied to the horizontal deflection circuit 140 through transformation thereof by the HDT 130. At operation S240, the horizontal deflection circuit 140 applies the horizontal deflection to the electron beam corresponding to the video signal on the display unit 150 on the basis of the driving current.

As described above, the present general inventive concept provides a video display apparatus and a video display method that can stably perform a horizontal deflection with regard to a high horizontal frequency.

Although a few embodiments of the present inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A video display apparatus, comprising:
a display unit;
a horizontal deflector to deflect a beam scanned onto the display unit based on a video signal including horizontal synchronization information;
a signal generator to generate a pulse signal having a predetermined duty ratio based on the horizontal synchronization information of the video signal;
a driver to transform a predetermined power source voltage into a driving current to drive the horizontal deflector based on the pulse signal and to output the driving current to the horizontal deflector;
a memory to store duty ratio information of the pulse signal corresponding to the driving current for the horizontal deflector; and
a controller to control the signal generator to generate the pulse signal having the duty ratio corresponding to the duty ratio information stored in the memory.

2. The video display apparatus according to claim 1, wherein the driver comprises:
a driving transformer to transform a current based on the power source voltage into the driving current; and
a switching circuit to control the current based on the power source voltage to selectively flow to the driving transformer according to the pulse signal.

3. The video display apparatus according to claim 1, wherein:
the horizontal deflector comprises a bipolar junction transistor to receive the driving current as a base current; and
the driving current corresponds to a current amplification ratio of the bipolar junction transistor.

4. A video display method useable with a video display apparatus comprising a display unit and a horizontal deflector to deflect a beam scanned onto the display unit based on a video signal including horizontal synchronization information, the video display method comprising:
storing duty ratio information of a pulse signal corresponding to a driving current to drive the horizontal deflector;
generating the pulse signal having a predetermined duty ratio based on the horizontal synchronization information of the video signal; and
transforming a predetermined power source voltage into the driving current to drive the horizontal deflector based on the pulse signal to output the driving current to the horizontal deflector.

5. The video display method according to claim 4, wherein:
the horizontal deflector comprises a bipolar junction transistor to receive the driving current as a base current; and
the driving current corresponds to a current amplification ratio of the bipolar junction transistor.

6. The video display apparatus of claim 2, wherein the switching circuit comprises a field effect transistor having a source connected to the driving transformer, a drain applied with the power source voltage, and a gate connected to the signal generator.

7. The video display apparatus of claim 6, wherein:
the driving transformer comprises a primary coil and a secondary coil,
the source and the drain of the field effect transistor are electrically connected with each other so that the current flows in the driving transformer to charge the primary coil of the driving transformer with energy when the pulse signal generated by the signal generator has a low logical state, and
the source and the drain of the field effect transistor are electrically disconnected from each other so that the current is induced from the primary coil into the secondary coil of the driving transformer by electromagnetic induction and transmitted to the bipolar junction transistor of the horizontal deflection unit when the pulse signal generated by the signal generator has a high logical state.

8. The video display apparatus of claim 6, wherein the driver comprises:
a capacitor to filter a direct current component from the signal transmitted from the signal generator to the gate of the field effect transistor; and
a resistor and a diode to adjust a driving level of the field effect transistor and to connect the gate of the field effect transistor to the driver.

9. The video display apparatus of claim 6, wherein the driver further comprises:
a resistor to protect the field effect transistor from an over current, the resistor being fusible and having a resistance of less than or equal to 1Ω; and
a plurality of capacitors to smooth the power source voltage.

10. A video display apparatus, comprising:
a signal generating unit to generate a pulse signal having a predetermined duty ratio based on horizontal synchronization information about a video signal;
a transforming unit to transform a current flowing therein caused by a power source;
a horizontal deflection circuit to use the transformed current to apply a horizontal deflection to an electron beam corresponding to a video signal; and
a drive circuit to control the current flow in the transforming unit based on the duty ratio of the pulse signal.

11. A video display apparatus according to claim 10, wherein the duty ratio is based on a predetermined optimum current to be supplied to the horizontal deflection circuit to horizontally deflect the electron beam.

12. The video display apparatus according to claim 11, wherein the transforming unit includes a primary coil and a secondary coil such that when the pulse signal generated by the signal generating unit is changed according to the duty ratio, the intensity of the current introduced into the horizontal deflection circuit via the primary and secondary coils is varied.

13. The video display apparatus of claim 10, wherein the drive circuit includes the transformer unit.

14. The video display apparatus of claim 10, further comprising:
a controller to determine a current amplification ratio and to control the signal generating unit to generate the pulse signal having the duty ratio corresponding to the current amplification ratio.

15. The video display apparatus of claim 10, further comprising:
a memory to store duty ratio information about the pulse signal.

16. The video display apparatus of claim 15, wherein:
the duty ratio information is information to increase the duty ratio of the pulse signal generated by the signal generating unit for a low current amplification ratio, or
the duty ratio information is information to decrease the duty ratio of the pulse signal generated by the signal generating unit for a high current amplification ratio.

17. A video display apparatus, comprising:
a controller to control a periodic generation of a pulse signal having a predetermined duty ratio;
a transformer unit to transform a first current flowing therefrom to a power source to a second current;
a horizontal deflection circuit to receive the transformed second current from the transformer and to apply a horizontal deflection to an electron beam corresponding to a video signal based on the second current; and
a drive circuit to receive the generated pulse signal and to control the current flowing from the transformer to the power source based on the duty ratio of the pulse signal.

18. A method of displaying an image on a video display apparatus including a signal generating unit, a transforming unit including a primary coil and a secondary coil, a horizontal deflection circuit including a bipolar junction transistor and a horizontal deflection coil, and a drive circuit, the method comprising:
periodically generating a pulse signal having a duty ratio using the signal generating unit;
transforming a first current flowing in the transforming unit into a second current using the transforming unit;
amplifying the second current by a current amplification ratio and applying a horizontal deflection to an electron beam corresponding to a video signal based on the amplified current using the horizontal deflection circuit; and
controlling the first current flowing in the transforming unit based on the duty ratio of the pulse signal using the drive circuit.

19. The method of claim 18, further comprising:
permitting the first current to flow in the primary coil when the pulse signal generated by the signal generator has a low logical state; and
inducing the first current from the primary coil into the secondary coil of the transforming unit by electromagnetic induction and transmitting the second current to the bipolar junction transistor of the horizontal deflection circuit when the pulse signal generated by the signal generator has a high logical state.

20. The method of claim 18, further comprising:
changing the duty ratio to a second duty ratio; and
controlling the first current flowing in the transforming unit based on the second duty ratio of the pulse signal using the drive circuit.
